(19) United States
(12) Patent Application Publication
(10) Pub. No.: US 2026/0055787 A1
(43) Pub. Date: Feb. 26, 2026

(54) KNOB LOCKING MECHANISM FOR SLUSH MACHINE, AND SLUSH MACHINE

(71) Applicant: GUANGDONG INVITOP TECHNOLOGY CO., LTD., Zhongshan (CN)

(72) Inventors: Yisheng Li, Zhongshan (CN); Yuangui Peng, Zhongshan (CN)

(73) Assignee: GUANGDONG INVITOP TECHNOLOGY CO., LTD., Zhongshan (CN)

(21) Appl. No.: 19/273,116

(22) Filed: Jul. 17, 2025

(30) Foreign Application Priority Data
Aug. 26, 2024 (CN) 2024220704590

(51) Int. Cl. F16B 5/06; A23G 9/04

(52) U.S. Cl. CPC F16B 5/0621; A23G 9/045

(57) ABSTRACT

A knob locking mechanism for a slush machine, and a slush machine are disclosed. The knob locking mechanism includes knobs and a plurality of limiting members. When assembling a loading container, a user aligns the loading container with the mounting position on the slush machine body and easily inserts the loading container, and by rotating the knobs provided on both sides of the slush machine body, the knobs drive the second limiting members to rotate until the second limiting members and the first limiting members are tightly engaged, thereby achieving the locking between the loading container and the slush machine body. The precise engagement between the limiting members enables the knob locking mechanism to ensure the stability and sealing performance of the loading container with low manual effort.

### CROSS-REFERENCE TO RELATED APPLICATION

This application is based on and claims the benefit of priority from Chinese Patent Application No. 2024220704590, filed on 26 August 2024, the entirety of which is incorporated by reference herein.

### TECHNICAL FIELD

The present disclosure relates to the technical field of household appliances, and in particular, to a knob locking mechanism for a slush machine, and a slush machine.

### BACKGROUND

The fixing and sealing of a loading container are crucial to the operation of a slush machine. Existing loading containers for slush machines are generally designed to store liquids, and are usually designed as detachable components to facilitate cleaning and maintenance. Such a design requires stable sealing performance to prevent liquid leakage at the interface between the loading container and the slush machine. Silicone sealing rings are often used at the interface to ensure sealing. However, while ensuring sealing, it is also necessary to prevent unintended detachment of the container during operation. Therefore, a reliable locking mechanism is needed for the connection between the loading container and the slush machine.

There are two commonly used fastening solutions in the market.

The first one is screw fastening. In this solution, the loading container is fixed to the machine by means of screws and nuts. This can provide a reliable fixing effect, but the operation process is cumbersome. Users have to turn the screws several times to ensure sufficient tightening, and usually have to tighten the left and right screws separately, which not only increases working time, but also requires more patience and manual skills from users.

The second one is snap-fit fastening. In this solution, a latching feature is provided on the front of the loading container, and users have to push the loading container into a catching position to achieve secure attachment. Although this design simplifies the operation to a certain extent, users have to work against a significant interface fit during assembly to ensure proper sealing. This makes the material loading operation require much manual effort, which may be difficult for some users, especially those with less physical strength, to complete the assembly and disassembly smoothly.

Both of the above solutions suffer from inconvenient operation in practical application. The solution of screw fastening can provide a stable connection, but the assembly or disassembly process requires multiple rotations of the screws, which makes the entire process time-consuming and requires a certain level of manual skill from users. This solution is particularly inconvenient for frequent assembly and disassembly. Although the solution of snap-fit fastening simplifies the operation, users have to overcome a significant counterforce during assembly, which makes it difficult to operate for some users, especially those with less physical strength. This not only affects the user experience, but may also lead to misoperation and affect the service life of the machine.

The present disclosure is proposed in view of the above shortcomings in the existing technologies.

### SUMMARY

The locking mechanisms for slush machines in the existing technologies described above have the technical problem of being inconvenient to operate.

The present disclosure uses the following technical solutions to address the technical problem described above.

A knob locking mechanism for a slush machine includes two knobs respectively provided on both sides of a slush machine body and first limiting members respectively provided on both sides of a loading container, where the two knobs are both rotatably provided on the slush machine body, and each of the knobs is provided with a second limiting member that corresponds to a respective one of the first limiting members; and when the knobs are rotated, the knobs are capable of driving the second limiting members to engage with the respective first limiting members, such that the loading container is locked to the slush machine body.

In the knob locking mechanism for a slush machine as described above, each of the first limiting members includes a first limiting column, each of the second limiting members includes a limiting recess, an opening in communication with the limiting recess is provided on a sidewall of the respective knob, the first limiting column is capable of entering and exiting the limiting recess through the opening, and the first limiting column is capable of approaching or abutting against an inner sidewall of the limiting recess.

In the knob locking mechanism for a slush machine as described above, the limiting recess has an inner diameter that gradually decreases from an end thereof having the opening to an end thereof without the opening.

In the knob locking mechanism for a slush machine as described above, the limiting recess includes a first arm, a top connecting segment, and a second arm that are connected in sequence, and the opening is located between the first arm and the second arm.

In the knob locking mechanism for a slush machine as described above, the limiting recess is substantially U-shaped, a length of the first arm is less than a length of the second arm, and the opening is configured to be inclined on the sidewall of the respective knob.

In the knob locking mechanism for a slush machine as described above, the knob locking mechanism further includes a limiting assembly provided between one or both of the knobs and the slush machine body, the limiting assembly is capable of limiting a rotation angle of the respective knob.

In the knob locking mechanism for a slush machine as described above, the limiting assembly includes a limiting groove provided on the respective knob and a second limiting column provided on the slush machine body, the limiting groove has a limiting passage, and the second limiting column extends into the limiting groove and is allowed for relative movement in the limiting passage.

In the knob locking mechanism for a slush machine as described above, the limiting groove includes a ring-like segment and an elastic segment, one end of the elastic segment is connected to one end of the ring-like segment, another end of the elastic segment is at a distance from another end of the ring-like segment, the elastic segment is capable of moving towards or away from the second limiting column based on the ring-like segment, a movement space for movement of the elastic segment is provided inside the respective knob, a limiting protrusion is provided on a side of the elastic segment facing the limiting passage, the limiting passage includes a locking area and a movement area that are connected to each other, the movement area allows for a relative movement of the second limiting column in the movement area, and an inner sidewall of the locking area is capable of engaging with the limiting protrusion to lock the second limiting column within the locking area.

In the knob locking mechanism for the slush machine as described above, a synchronizing shaft that enables the two knobs to rotate synchronously is provided between the two knobs.

A slush machine includes the slush machine body, a loading container, and a knob locking mechanism as described above, where a sealing component is provided between the slush machine body and the loading container, and when the loading container is locked to the slush machine body by means of the knob locking mechanism, the sealing component provides a sealed connection between the slush machine body and the loading container.

The beneficial effects of the present disclosure are as follows.

The present disclosure provides a knob locking mechanism for a slush machine and a slush machine, which relates to the technical field of household appliances. When assembling a loading container, a user aligns the loading container with the mounting position on a slush machine body and inserts the loading container easily. Then, by rotating knobs respectively provided on both sides of the slush machine body, the knobs drive respective second limiting members to rotate until the second limiting members engage with respective first limiting members, so as to finally lock the loading container to the slush machine body. The precise engagement between the limiting members enables the knob locking mechanism to ensure the stability and sealing performance of the loading container with low manual effort. Compared with traditional screw fastening and snap-fit fastening, as the force transmission efficiency is taken into account in the design of the knob, the tight engagement between the limiting members can be achieved by means of a rotating operation, thereby enabling users to fix or detach the loading container by easily rotating the knob, which enhances the convenience of use.

The present disclosure will be further described in detail below in conjunction with the accompanying drawings and embodiments.

### BRIEF DESCRIPTION OF DRAWINGS

FIG. 1 is a structural schematic diagram of knobs assembled with a synchronizing shaft, according to the present disclosure;

FIG. 2 is a schematic top view of a slush machine according to the present disclosure;

FIG. 3 is a first schematic cross-section view taken along line A-A in FIG. 2, with a knob locking mechanism being in a locked state;

FIG. 4 is a second schematic cross-section view taken along line A-A in FIG. 2, with a knob locking mechanism being in an unlocked state;

FIG. 5 is a structural schematic diagram of a slush machine according to the present disclosure;

FIG. 6 is a first schematic exploded view of a slush machine according to the present disclosure; and

FIG. 7 is a second schematic exploded view of a slush machine according to the present disclosure.

### DETAILED DESCRIPTION

The embodiments of the present disclosure will be described in detail below in conjunction with the accompanying drawings.

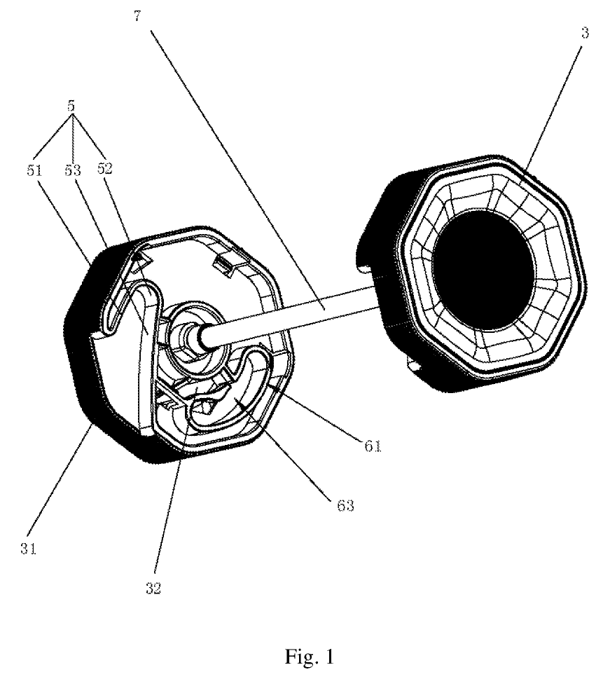

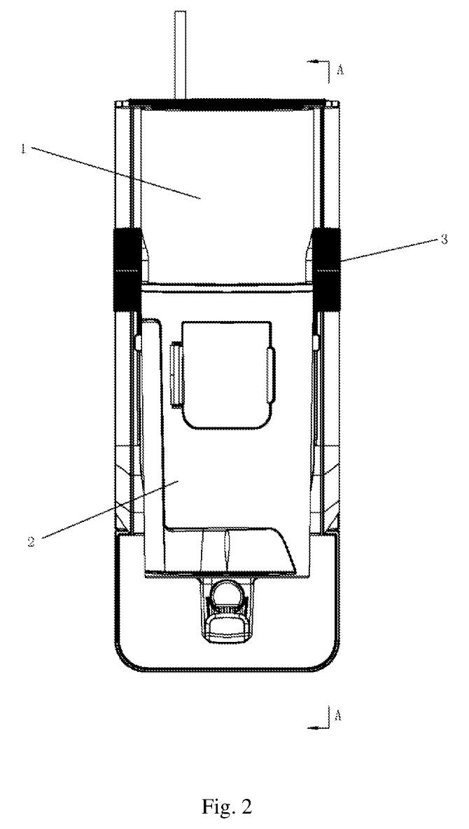

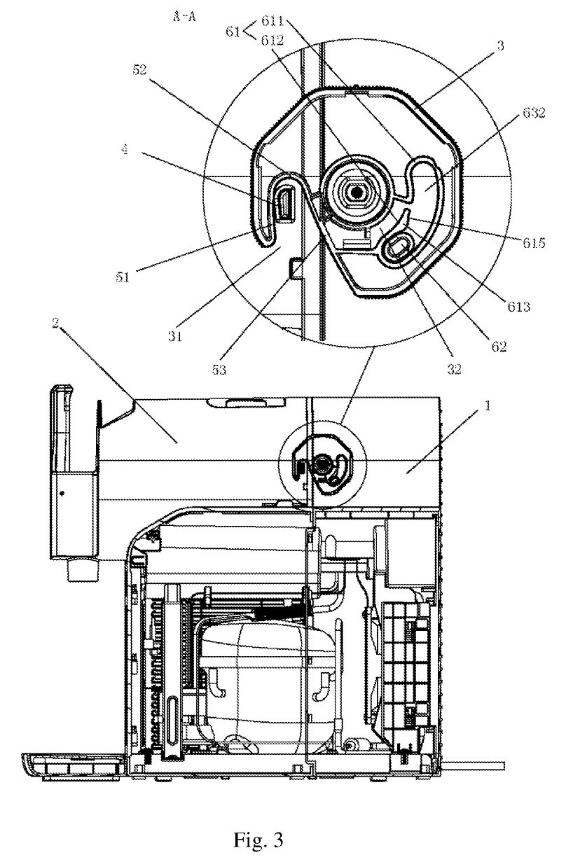

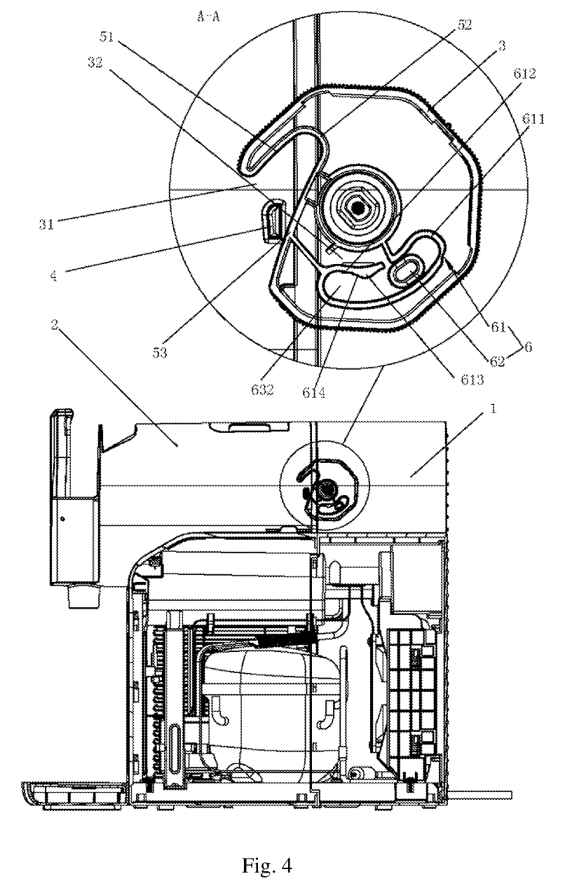

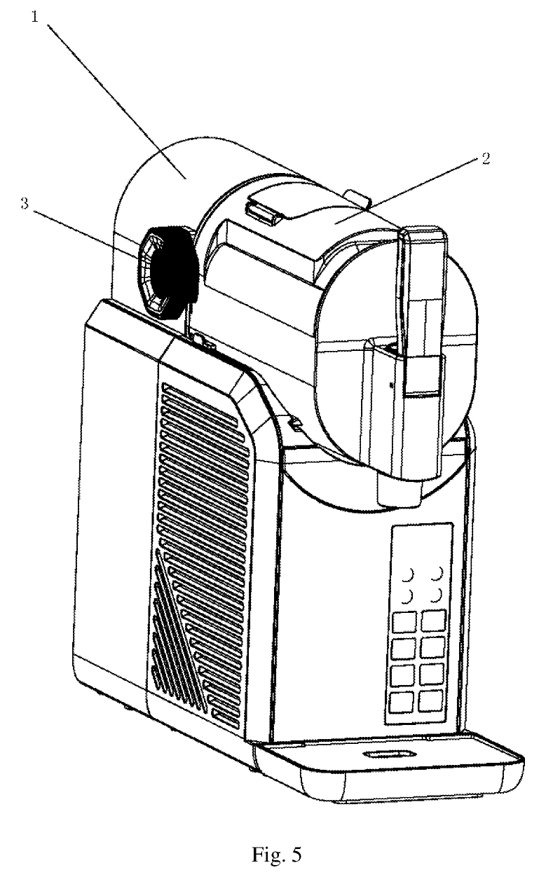

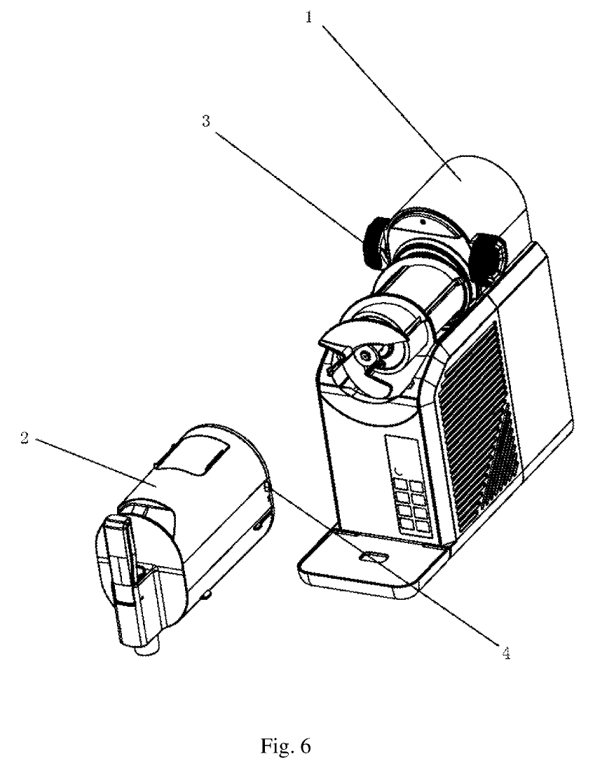

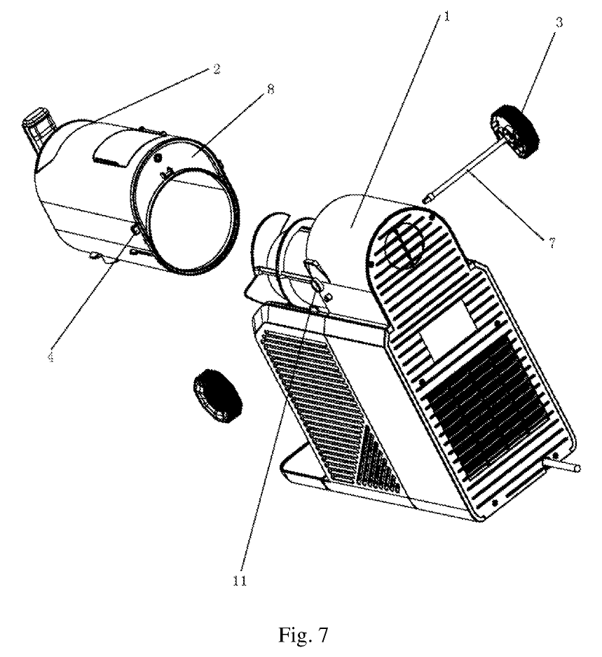

As shown in FIGS. 1 to 7, in an embodiment, a knob locking mechanism for a slush machine includes knobs 3 respectively provided on both sides of a slush machine body 1 and first limiting members 4 respectively provided on both sides of the loading container 2. The two knobs 3 are rotatably provided on the slush machine body 1. Each knob 3 is provided with a second limiting member 5 that corresponds to the first limiting member 4. When the knob 3 is rotated, the knob 3 can drive the second limiting member 5 to engage with the first limiting member 4 to lock the loading container 2 to the slush machine body 1.

Specifically, each side of the slush machine body 1 is provided with a knob 3 that can rotate freely around its axis. The design of the knob 3 facilitates manual rotation, and a user can achieve a locking or unlocking operation by rotating the knob. The second limiting member 5 is provided on the knob 3. The first limiting members 4 are fixedly mounted on both sides of the loading container 2 respectively. When the user rotates the knob 3, the second limiting member 5 moves relative to the first limiting member 4 with the rotation of the knob to achieve the engagement therebetween, thereby achieving a stable connection between the loading container and the slush machine body.

Specifically, when assembling the loading container 2, the user aligns the loading container with the mounting position on the slush machine body 1, and easily inserts the loading container 2 therein. Then, by means of the rotation of the knobs 3 respectively provided on both sides of the slush machine body 1, the knobs 3 drive the second limiting members 5 to rotate until the second limiting members 5 tightly engages with the first limiting members 4, so as to finally lock the loading container 2 to the slush machine body 1. The precise engagement between the limiting members enables the knob locking mechanism to ensure the stability and sealing performance of the loading container with low manual effort. Compared to traditional screw fastening and snap-fit fastening, users can fix or detach the loading container by easily rotating the knobs, greatly simplifying the operating steps and enhancing the ease of use.

As the force transmission efficiency is taken into account in the design of the knob, the tight engagement between the limiting members can be achieved by means of a rotation operation, requiring less physical strength from users and being particularly suitable for users with limited physical strength.

In addition, the high engagement accuracy between the limiting members can achieve reliable locking with low manual effort, and ensuring the stability of the loading container during use, while ensuring the sealing performance.

As shown in FIGS. 1 to 7, in this embodiment, each of the first limiting members 4 includes a first limiting column, and each of the second limiting members 5 includes a limiting recess. An opening 31 that communicates with the limiting recess is provided on the sidewall of the respective knob 3. The first limiting column can enter and exit the limiting recess through the opening 31. The design of the limiting recess allows the first limiting column to move freely in and out during assembly and disassembly, facilitating locking and unlocking.

When the knob 3 is rotated until the first limiting column is close to or abuts against the inner sidewall of the limiting recess, the loading container 2 is locked to the slush machine body 1.

The user aligns the loading container 2 with the slush machine body 1 and inserts the loading container 2. Then, the user rotates the knob 3. As the knob rotates, the limiting recess in the second limiting member 5 gradually aligns with the first limiting column. When the first limiting column enters the limiting recess through the opening 31, the first limiting column gradually abuts against the inner sidewall of the limiting recess. At this time, the loading container 2 is locked to the slush machine body 1, ensuring a stable and sealed connection.

When the user rotates the knob 3 in an opposite direction, the first limiting column can move out of the limiting recess through the opening 31. By means of reverse rotation of the knob in the opposite direction, the first limiting column exits the limiting recess, and the loading container 2 can be disassembled smoothly.

Such a design ensures that the first limiting column can quickly engage with the limit recess during the rotation of the knob, ensuring a simple and efficient locking process. In addition, users only need to rotate the knob to achieve the locking and unlocking, being simple in operation, requiring no additional tools or force, and being suitable for a wide range of users.

Further, the design as to the engagement between the first limiting column and the limiting recess enhances the stability of the loading container during use, preventing looseness caused by shaking or other external forces.

Preferably, in some other embodiments, the first limiting column is close to the inner sidewall of the limiting recess, and the distance therebetween is to provide a clearance for the sealing component 8. When the loading container 2 is inserted into the slush machine body 1, the sealing component 8 will be compressed. When the force on the loading container 2 is removed, the sealing component 8 will elastically recover, and at this time, the loading container 2 will be driven to move away from the slush machine body 1, thereby driving the first limiting column to compress the limiting recess. The design of providing the first limiting column close to the inner sidewall of the limiting recess with a certain distance therebetween is to prevent the first limiting column from excessively compressing the limiting recess, which may cause damage to the first limiting column or the limiting recess. An appropriate design can be selected as required.

As shown in FIGS. 1 to 7, in this embodiment, the limiting recess has an inner diameter that gradually decreases from an end thereof having the opening 31 to an end thereof without the opening 31. With such a design, the opening 31 of a large size is convenient for the first limiting column to enter the limiting recess through the opening. The design of large opening 31 eliminates the need for precise alignment during assembly, thereby reducing the technical difficulty of the operation. Users only need to rotate the knobs normally to enable the first limiting column to easily enter the limiting recess, greatly improving the assembly efficiency of the loading container, and avoiding assembly difficulties caused by size mismatches. By means of a large opening 31, users can operate more easily without the need for strenuous alignment. This is suitable for a wide range of users, especially those with limited physical strength or insufficient operational experience.

Further, after the first limiting column enters the limiting recess, as the knob is further rotated, the gradually decreasing inner diameter of the limiting recess enables the first limiting column to gradually approach the inner sidewall of the limiting recess until the inner sidewall of the limiting recess abuts against the first limiting column. This not only improves the stability of locking, but also enhances the sealing performance of the connection and prevents liquid leakage.

As shown in FIGS. 1 to 7, in an embodiment, the limiting recess includes a first arm 51, a top connecting segment 52, and a second arm 53 that are connected in sequence. The top connecting segment 52 connects the first arm 51 and the second arm 53 to form a connecting area of the limiting recess to maintain the entire structural strength of the limiting recess. The opening 31 is located between the first arm 51 and the second arm 53. Specifically, when the first limiting column abuts against the first arm 51, the loading container 2 is locked to the slush machine body 1. When the knob rotates in the reverse direction and the first limiting column abuts against the second arm 53, the knob can no longer rotate in the reverse direction, thereby preventing excessive rotation of the knob.

Specifically, the user inserts the loading container 2 into the slush machine body 1, and rotates the knob 3 to enable the first limiting column to enter the limiting recess through the opening 31. When the knob continues to rotate, the first arm 51 approaches the first limiting column until it abuts against the first limiting column. At this time, the loading container 2 is locked to the slush machine body 1 to ensure stability.

With such a design, the first arm 51 and the second arm 53 form a dual-locking mechanism, ensuring that the loading container is firmly locked when the knob is rotated into place, and preventing looseness or detachment due to reverse rotation.

As shown in FIGS. 1 to 7, in an embodiment, the limiting recess is substantially U-shaped, and has two arms, namely a first arm 51 and a second arm 53, and a top connecting segment 52 that connects the two arms. The design of the substantially U-shaped structure can provide a clear path for the first limiting column, thereby ensuring a smooth and reliable locking or unlocking process.

Specifically, the length of the first arm 51 is less than the length of the second arm 53. The design of the first arm 51 with a less length enables a more rapid locking process. When the first limiting column abuts against the first arm 51, the locking action is completed immediately, reducing the operation time. Moreover, as the first arm 51 has a less length, users only need to rotate the knob slightly to complete a locking process, greatly improving the efficiency of operation.

The second arm 53 of a greater length serves to limit the excessive rotation of the knob during an unlocking process, providing more clearance space to ensure that the knob will not be damaged or the locking effect will not be affected due to excessive rotation, thereby improving the overall service life and safety of the knob.

The opening 31 is configured to be inclined on the sidewall of the knob 3. The design of the inclined opening enables the first limiting column to be inserted more naturally, reducing the difficulty of alignment, and ensuring that the limiting column can slide smoothly into the limiting recess, thereby improving the smoothness of operation.

As shown in FIGS. 1 to 7, in an embodiment, the knob locking mechanism further includes a limiting assembly 6 provided between one or both of the knobs 3 and the slush machine body 1, and the limiting assembly 6 can limit the rotation angle of the knob 3.

When the user rotates the knob 3, the limiting assembly 6 allows the knob to rotate normally within a preset angular range to complete the locking or unlocking of the loading container. Once the knob rotates to a preset limit position, the limiting assembly 6 will prevent further rotation of the knob, thereby avoiding damage or misoperation caused by excessive rotation of the knob.

Preferably, the limiting assembly 6 can work in conjunction with the limiting recess. The limit recess enables locking and unlocking by means of the first arm 51 and the second arm 53 therein, while the limiting assembly further ensures that the knob can only rotate within a specific range, doubly ensuring the reliability and security of operation.

In other embodiments, the knob locking mechanism may utilize either the limiting assembly 6 or the second arm 53 alone to prevent excessive rotation of the knob 3. A suitable design may be selected as required.

As shown in FIGS. 1 to 7, in an embodiment, the limiting assembly 6 includes a limiting groove 61 provided on the knob 3 and a second limiting column 62 provided on the slush machine body 1. The limiting groove 61 has a limiting passage 63. The second limiting column 62 extends into the limiting groove 61, and is allowed for relative movement in the limiting passage 63.

Specifically, the limiting groove 61 is a recessed structure located on the inner surface or sidewall of the knob 3. The limiting groove 61 extends in the direction of rotation of the knob, forming a limiting passage 63 that engages with the second limiting column 62. The limiting passage 63 is a path with a specific length and shape. The design of the limiting passage determines the range of movement of the second limiting column 62 during the rotation of the knob, thereby limiting the rotation angle of the knob.

Specifically, the second limiting column 62 is fixed on the slush machine body 1 and extends vertically or obliquely into the limiting groove 61. The limiting column is configured to come into contact with the inner sidewall of the limiting groove 61 when the knob is rotated to a certain position, and to limit the rotation range of the knob by moving within the limiting passage 63.

Specifically, when the user rotates the knob 3, the second limiting column 62 is allowed for relative movement in the limiting passage 63. When the knob is rotated to a preset locked position, the second limiting column 62 reaches the end of the limiting passage 63, preventing further rotation of the knob, ensuring that the knob remains in the locked position, cooperating with the first arm 51 and the first limiting column to complete the locking of the loading container. It can also prevent continuous rotation of the knob 3 in the same direction, which may cause the first arm 51 to over-press the first limiting column.

When the knob is rotated in the reverse direction, the second limiting column 62 is allowed for relative movement in the limiting passage 63 in the opposite direction.

In other embodiments, when the knob is rotated in the reverse direction, the second limiting column 62 is allowed for relative movement in the limiting passage 63 in the opposite direction. When the knob reaches the unlocked position, the second limiting column 62 can move to the other end of the limiting passage 63 to prevent further rotation of the knob, thereby ensuring the unlocking of the loading container without excessive rotation.

Specifically, by means of the precise design of the limiting passage 63, the limiting assembly can control the rotation of the knob within a specific range to prevent mechanical failure or misoperation caused by excessive rotation. In the process of the second limiting column 62 moving relative to the limiting groove 61, the limiting passage 63 can provide a stable mechanical feedback to ensure smooth operation of the knob and prevent possible shaking or looseness during rotation.

Further, the limiting assembly effectively prevents excessive rotation due to misoperation of a user, thereby enhancing the safety of the locking and unlocking operations and providing additional security, particularly during rapid operations or in cases of user inexperience.

As shown in FIGS. 1 to 7, in an embodiment, the limiting groove 61 includes a ring-like segment 611 and an elastic segment 612. One end of the elastic segment 612 is connected to one end of the ring-like segment 611, and the other end of the elastic segment 612 is at a certain distance from the other end of the ring-like segment 611. The elastic segment 612 can move towards or away from the second limiting column 62 based on the ring-like segment 611. A movement space 32 for the movement of the elastic segment 612 is provided inside the knob 3. A limiting protrusion 613 is provided on a side of the elastic segment 612 facing the limiting passage 63. The limiting passage 63 includes a locking area 631 and a movement area 632 that are connected to each other. The movement area 632 can allow for a relative movement of the second limiting column 62 therein, and the inner sidewall of the locking area 631 can engage with the limiting protrusion 613 to lock the second limiting column 62 in the locking area 631.

Specifically, the ring-like segment 611 is the main part of the limiting recess and is partially ring-shaped, and the elastic segment 612 is connected to both ends of the ring-like segment 611 to form a movable structure. The ring-like segment 611 and the elastic segment 612 are combined to form the limiting groove 61.

Specifically, when the knob is gradually rotated to a preset locked position and the second limiting column 62 gradually enters the locking area 631, the second limiting column 62 can gradually force the limiting protrusion 613, thereby causing the elastic segment 612 to elastically deform and move away from the second limiting column 62. When the second limiting column 62 completely enters the locking area 631, the second limiting column 62 no longer forces the limiting protrusion 613. At this time, the elastic segment 612 elastically recovers, and the inner sidewall of the elastic segment 612, part of the sidewall of the limiting protrusion 613 and the inner sidewall of the locking area 631 are all close to or abut against the second limiting column 62, such that the second limiting column 62 is locked in the locking area 631, preventing further rotation of the knob, thereby completing the locking of the loading container.

When the user rotates the knob in the reverse direction, the second limiting column 62 moves relative to the limiting passage 63 in the opposite direction. At this time, the second limiting column 62 can gradually force the limit protrusion 613, such that the elastic segment 612 elastically deforms and moves away from the second limiting column 62. When the second limiting column 62 completely exits the locking area 631 and completely enters the movement area 632, the second limiting column 62 no longer forces the limit protrusion 613. At this time, the elastic segment 612 elastically recovers, and the entire inner sidewall of the movement area 632 is close to or abuts against the second limiting column 62, thereby releasing the locking. Moreover, under the restriction of the inner sidewall of the movement area 632, the knob is allowed to continue to rotate to the unlocked position.

Specifically, a stable locking mechanism is provided by means of the cooperation between the limiting protrusion 613, the elastic segment 612 and the locking area 631, ensuring that the knob does not rotate unexpectedly due to external forces in the locked position. The design of the elastic segment 612 enables a smooth operation of the knob during the locking and unlocking processes, reducing mechanical impact and wear. The movable design of the elastic segment provides a certain degree of operational flexibility, enables smooth locking and unlocking even in the case of slight deviations.

As shown in FIGS. 1 to 7, in an embodiment, the limiting protrusion 613 has an arc-shaped cross-section. Specifically, a first arc surface 614 and a second arc surface 615 are provided on both sides of the limiting protrusion 613 respectively. The first arc surface 614 is located in the locking area 631, and the second arc surface 615 is located in the movement area 632. Such a design can reduce the friction between the second limiting column 62 and the limiting protrusion 613 during the locking and unlocking processes and achieve smooth locking or unlocking by means of progressive contact between the second limiting column 62 and the arc surfaces, thereby improving the smoothness of operation and preventing sudden jamming or jerking.

As shown in FIGS. 1 to 7, in this embodiment, a synchronizing shaft 7 that enables the two knobs to rotate synchronously is provided between the two knobs 3.

Specifically, the synchronizing shaft 7 is provided between the two knobs 3 to serve as a connecting component therebetween. One end of the synchronizing shaft is connected to a first knob 3, and the other end thereof is connected to a second knob 3. Such a connection ensures the synchronous operation of the knobs. When the user rotates one of the knobs, the synchronizing shaft 7 transmits the rotational force to the other knob, ensuring that the two knobs rotate synchronously at the same speed and angle, thereby maintaining synchronous movement of the two knobs at all times. This ensures that during locking and unlocking, the two knobs complete corresponding operations simultaneously, preventing the occurrence of a single knob being not completely locked or unlocked. The design of the synchronizing shaft effectively prevents misoperation of a single knob during locking or unlocking, ensuring that the loading container can be reliably locked or unlocked in each operation.

Further, the user only needs to rotate one knob to achieve synchronized operation of the two knobs, reducing the operation procedures and improving the convenience and efficiency of operation.

As shown in FIGS. 1 to 7, in this embodiment, a slush machine includes a slush machine body 1, a loading container 2, and a knob locking mechanism as described in any of the above embodiments. A sealing component 8 is provided between the slush machine body 1 and the loading container 2. When the loading container 2 is locked to the slush machine body 1 by means of the knob locking mechanism, the sealing component 8 can provide a sealed connection between the slush machine body 1 and the loading container 2.

Specifically, the slush machine body 1 is the core part of the entire slush machine, and contains various mechanical and electronic components used for snow melting. The slush machine body 1 is provided with an interface for connecting the loading container 2, and a mounting component that engages with the knob locking mechanism. The loading container 2 is used to hold the snow or ice to be processed. By means of the knob locking mechanism, the loading container 2 can be firmly fixed to the slush machine body 1 and can be easily detached after the operation is completed.

Specifically, the sealing component 8 is a crucial sealing component between the loading container 2 and the slush machine body 1, and is usually made of an elastic material, such as a silicone ring, a rubber pad, etc. The sealing component is located around the opening of the loading container 2 and corresponds to the interface of the slush machine body 1. When the loading container 2 is locked to the slush machine body 1 by means of the knob locking mechanism, the sealing component 8 is compressed therebetween to form an effective sealing layer to prevent leakage of melted snow or other liquids.

Specifically, a user may put snow or ice into the loading container 2, and then align the opening of the loading container with the interface of the slush machine body 1. By means of rotation of the knob 3, the synchronizing shaft 7 drives the two knobs to rotate synchronously, such that the knob locking mechanism firmly fixes the loading container 2 to the slush machine body 1. When the loading container 2 is firmly locked by means of the knob locking mechanism, the sealing component 8 is automatically compressed between the loading container and the slush machine body, and the sealing component made of the elastic material deforms under pressure to completely fill the gap between the loading container 2 and the slush machine body 1, thereby forming a reliable seal.

After the operation is completed, the user may rotate the knob 3 to unlock the loading container 2, and the sealing component 8 returns to its initial state, enabling the loading container to be easily detached, for cleaning or refilling.

By means of the knob locking mechanism, the user can easily assemble and disassemble the loading container, and the automatic sealing of the sealing component 8 reduces the user’s workload.

Preferably, the slush machine body 1 is provided with a rotation passage 11 for mounting the synchronizing shaft 7. The rotation passage 11 passes through both sides of the slush machine body 1, such that both ends of the synchronizing shaft 7 are connected to respective knobs 3.

The embodiments described herein are for illustration purposes only for a better understanding of the present disclosure, and are not intended to limit the present disclosure. Any technical extension or further creation made on the basis of the present disclosure falls within the scope of protection as defined by the claims of the present disclosure.

What is claimed is:

1. A knob locking mechanism for a slush machine, comprising:
two knobs respectively provided on both sides of a slush machine body; and first limiting members respectively provided on both sides of a loading container, wherein the two knobs are both rotatably provided on the slush machine body, and each of the knobs is provided with a second limiting member that corresponds to a respective one of the first limiting members; and when the knobs are rotated, the knobs are capable of driving the second limiting members to engage with the respective first limiting members, such that the loading container is locked to the slush machine body.

2. The knob locking mechanism for a slush machine according to claim 1, wherein each of the first limiting members comprises a first limiting column, each of the second limiting members comprises a limiting recess, an opening in communication with the limiting recess is provided on a sidewall of the respective knob, the first limiting column is capable of entering and exiting the limiting recess through the opening, and the first limiting column is capable of approaching or abutting against an inner sidewall of the limiting recess.

3. The knob locking mechanism for a slush machine according to claim 2, wherein the limiting recess has an inner diameter that gradually decreases from an end of the limiting recess having the opening to an end of the limiting recess without the opening.

4. The knob locking mechanism for a slush machine according to claim 2, wherein the limiting recess comprises a first arm, a top connecting segment, and a second arm that are connected in sequence, and the opening is located between the first arm and the second arm.

5. The knob locking mechanism for a slush machine according to claim 4, wherein the limiting recess is substantially U-shaped, a length of the first arm is less than a length of the second arm, and the opening is configured to be inclined on the sidewall of the respective knob.

6. The knob locking mechanism for a slush machine according to claim 1, wherein the knob locking mechanism further comprises a limiting assembly provided between one or both of the knobs and the slush machine body, the limiting assembly is capable of limiting a rotation angle of the respective knob.

7. The knob locking mechanism for a slush machine according to claim 6, wherein the limiting assembly comprises a limiting groove provided on the respective knob and a second limiting column provided on the slush machine body, the limiting groove has a limiting passage, and the second limiting column extends into the limiting groove and is allowed for relative movement in the limiting passage.

8. The knob locking mechanism for a slush machine according to claim 7, wherein the limiting groove comprises a ring-like segment and an elastic segment, one end of the elastic segment is connected to one end of the ring-like segment, another end of the elastic segment is at a distance from another end of the ring-like segment, the elastic segment is capable of moving towards or away from the second limiting column based on the ring-like segment, a movement space for movement of the elastic segment is provided inside the respective knob, a limiting protrusion is provided on a side of the elastic segment facing the limiting passage, the limiting passage comprises a locking area and a movement area that are connected to each other, the movement area allows for a relative movement of the second limiting column in the movement area, and an inner sidewall of the locking area is capable of engaging with the limiting protrusion to lock the second limiting column within the locking area.

9. The knob locking mechanism for a slush machine according to claim 1, wherein a synchronizing shaft that enables the two knobs to rotate synchronously is provided between the two knobs.

10. A slush machine, comprising: a slush machine body, a loading container, and the knob locking mechanism according to claim 1, wherein a sealing component is provided between the slush machine body and the loading container, and when the loading container is locked to the slush machine body by means of the knob locking mechanism, the sealing component provides a sealed connection between the slush machine body and the loading container.
